(19) United States
(12) Patent Application Publication
(10) Pub. No.: US 2010/0183759 A1
(43) Pub. Date: Jul. 22, 2010

(54) Roller for Pelleting Mill

(76) Inventor: Carl R. Allis, Crawfordsville, IN (US)

Correspondence Address: SQUIRE, SANDERS & DEMPSEY L.L.P., 1 MARITIME PLAZA, SUITE 300, SAN FRANCISCO, CA, 94111, US

(21) Appl. No.: 12/357,141

(22) Filed: Jan. 21, 2009

(51) Int. Cl. B29C 47/00

(52) U.S. Cl. 425/289

(57) ABSTRACT

A pellet mill includes a die carrying material to be extruded into pellets. The die rotates to bring the material toward rollers within the die. The rollers push the material through extrusion holes in the die. The rollers are mounted on and rotate about support shafts that are held stationary within the die. Sealing devices at the ends of the rollers prevent foreign material from interfering with bearings between the rollers and the support shafts. Each of the sealing devices include one or more sealing elements. The sealing elements may include a pair of mating grooves and protrusions.

### FIELD OF THE INVENTION

This invention relates generally to pelletizing machinery and, more particularly, a roller assembly for a pelleting mill.

### BACKGROUND OF THE INVENTION

Pellet mills are used to form a variety of pellet products from various grains or other particulate material. As shown in FIG. 1, a conventional pellet mill 10 includes a die 12 that carries particulate material 14 to be made into pellets 16. As the die rotates about its central axis 17, rollers 18 inside the die rotate about their respective central axes 19 and force the material 14 through extrusion holes 20 in the die. Rotation of the rollers 18 allows for proper and efficient extrusion of the material 14. The extruded material that exits the die may be sheared off by blades 22 located outside the die.

Referring to FIG. 2, the particulate material is fed into one end 24 of the die 12. The die 12 is connected to and rotated by a flange 26 at the end of a quill shaft 28. The quill shaft is tubular in that it has a central opening that contains a normally stationary mainshaft 30. The mainshaft is used to carry the rollers 18 inside the die. Since the mainshaft is stationary, the roller axes 19 are kept at the same location inside the die while the die rotates.

A problem with conventional rollers is that they require frequent or continuous lubrication because of their tendency to leak lubrication and the tendency of foreign material to find their way inside the rollers. Frequent or continuous lubrication replaces lubrication that has leaked out and helps to flush out foreign material. Without lubrication replenishment and flushing, rollers would become damaged within a few hours of operation. Another problem with conventional rollers is that pellets can become contaminated by the lubricant that leaks out. Yet another disadvantage is the need to periodically monitor and purchase lubricant, which increases the cost of operations.

Accordingly, there is a need to keep the rollers rotating without frequent or continuous lubrication, to increase the purity of the pellets produced, and to decrease the cost of operations.

### SUMMARY OF THE INVENTION

Briefly and in general terms, the present invention is directed to a roller assembly for a pellet mill.

In aspects of the present invention, a roller assembly comprises a roller having a bore, the roller including an axially facing surface at an open end of the bore. The roller also comprises a collar at the open end of the bore, the collar including a collar body, a flange protruding radially outward from the collar body, and a seal portion protruding axially from the flange and into the axially facing surface of the roller. In further aspects, one of the annular seal feature of the at least one end face and the annular seal feature of the first seal device is an annular groove. In still further aspects, the other one of the annular seal feature of the at least one end face and the annular seal feature of the first seal device is an annular protrusion disposed in the annular groove.

In other aspects of the present invention, a roller assembly comprises a roller having a bore, the roller including an axially facing surface at an open end of the bore. The assembly also comprises a collar at the open end of the bore, the collar including a collar body, a flange protruding radially outward from the collar body, and a seal portion protruding axially from the flange and into the axially facing surface of the roller. In detailed aspects, the collar body includes a radially outward facing surface, the flange protruding radially outward from the radially outward facing surface, and wherein the roller includes a radially inward facing surface spaced apart from the radially outward facing surface of the collar body. In other detailed aspects, the assembly further comprises a seal member disposed between and in sealing contact with the radially outward facing surface of the collar body and the radially inward facing surface of the roller.

A roller assembly in some aspects of the present invention comprises a central support, a bearing on the central support, and a roller on the bearing, the roller adapted to rotate around the central support, the roller including an end face having a ring-shaped feature. The assembly also comprises a seal device including a seal element in a sealing relationship with the ring-shaped feature of the roller end face.

The features and advantages of the invention will be more readily understood from the following detailed description which should be read in conjunction with the accompanying drawings.

### BRIEF DESCRIPTION OF THE DRAWINGS

FIG. 1 is a front, cross-sectional view of a pelleting die assembly showing rollers and blades on the inner and outer surfaces of a rotating die.

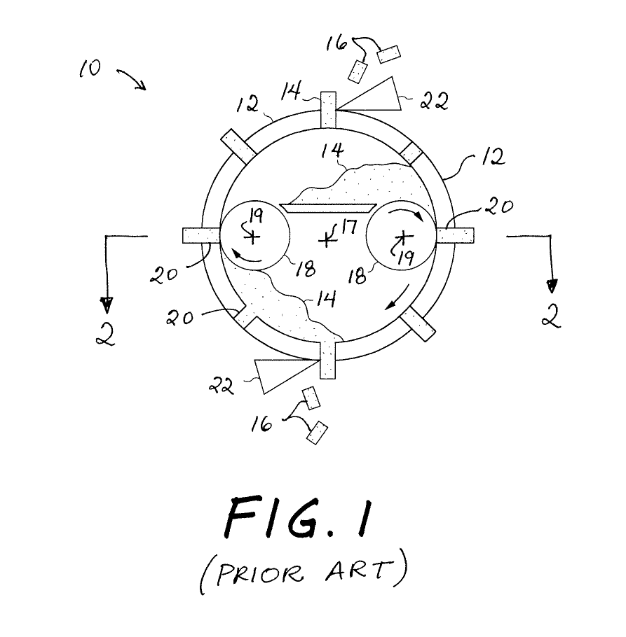

FIG. 2 is a partial cross-sectional view of the pelleting die of FIG. 1 showing the rollers attached to a mainshaft.

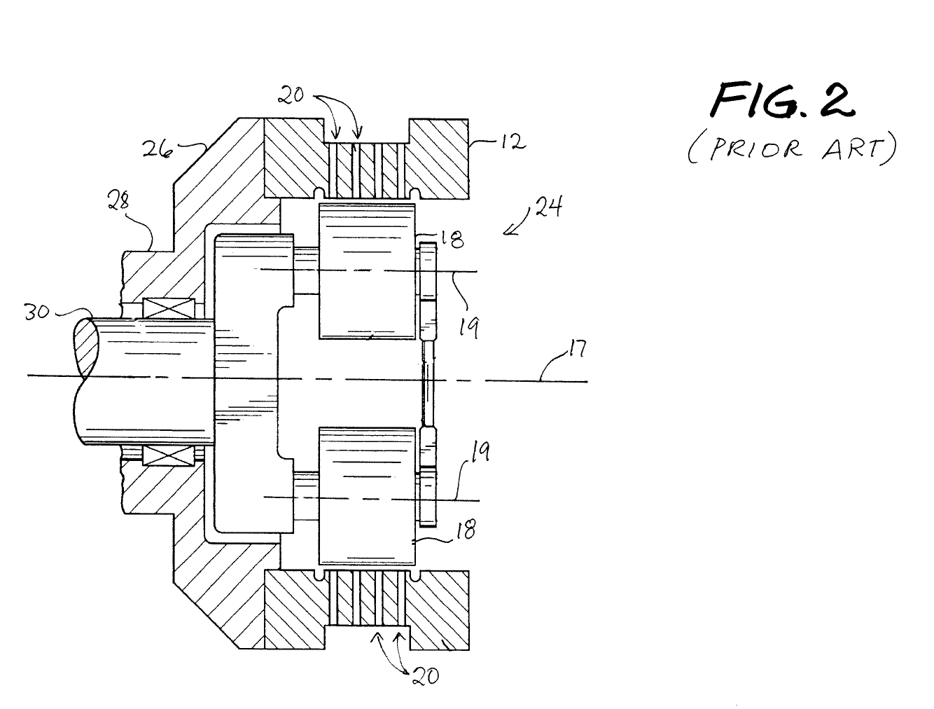

FIG. 3 is a cross-sectional view of a roller assembly showing a hollow cylinder mounted over bearings that are sealed between two sealing devices at open ends of the cylinder.

FIG. 4 is a detailed, cross-sectional view of a labyrinth seal of the roller assembly of FIG. 3 showing a plurality of seal segments.

FIG. 5 is a cross-sectional view of a roller assembly showing two labyrinth seals at opposite ends of a hollow cylinder.

FIG. 6 is a detailed, cross-sectional view of a labyrinth seal of the roller assembly of FIG. 5.

FIG. 7 is a partial, cross-sectional view of a roller assembly showing a roller carried by rotational bearings encased between the roller, a central support, and two collars.

FIG. 8 is a perspective view of an open end of the roller of FIG. 7, showing a bore running through the roller and a counterbore at an open end.

FIG. 9 is a partial, cross-sectional view of one of the two collars of FIG. 7, showing two seal elements, one of the seal elements protruding into the roller, the other seal element supporting a seal member in a sealing relationship with the counterbore.

FIG. 10 is an exploded view showing the sealing member of FIG. 9, a portion of the collar, and a portion of the roller.

### DETAILED DESCRIPTION OF THE INVENTION

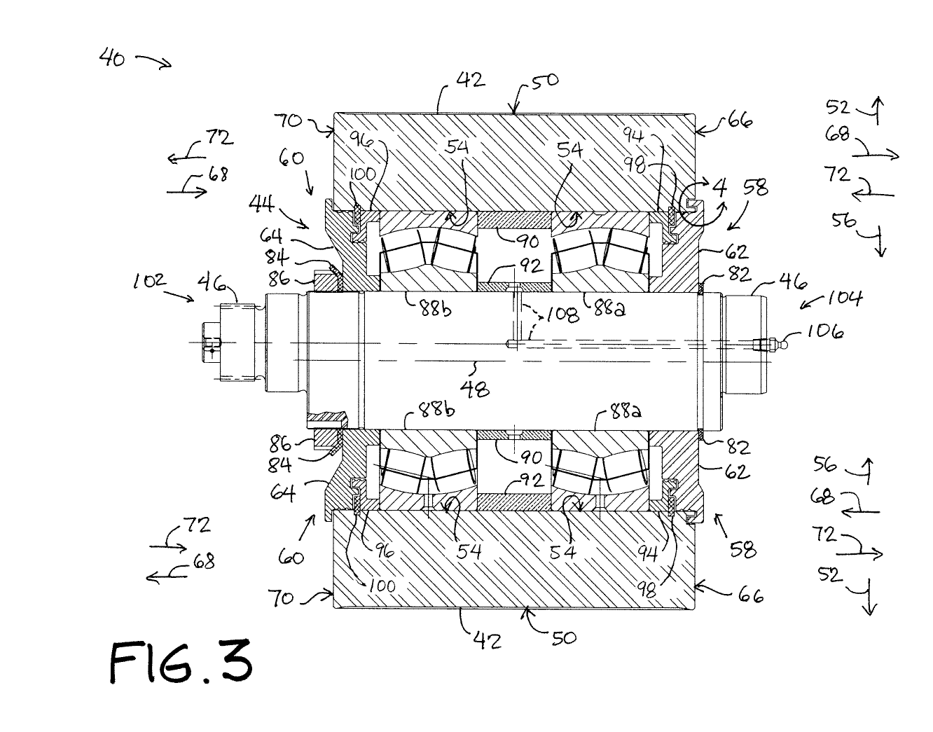

Referring now in more detail to the exemplary drawings for purposes of illustrating embodiments of the invention, wherein like reference numerals designate corresponding or like elements among the several views, there is shown in FIG. 3 a roller assembly 40 for use with a pellet mill.

The roller assembly includes a hollow cylinder 42 having a central bore 44 in which other components are located. The hollow cylinder is adapted to rotate about a shaft 46 extending through the central bore 44. The rotational axis of the hollow cylinder is depicted as line 48. The cylinder 42 has a curved, outer surface 50 that is exposed, faces in a radially outward direction 52, and is adapted to push particulate material into extrusion holes of a pellet die of the pellet mill. The cylinder 42 also has a curved, inner surface 54 that faces in a radially inward direction 56, and is adapted to cooperate with components in the central bore 44. The cylinder 42 may be made of steel, stainless steel, and other metals and alloys.

The central bore 44 has a rear opening 58 and a forward opening 60. A first seal device 62 is located at the rear opening 58 and is adapted to prevent particulate material from entering the rear opening. A second seal device 64 is located at the forward opening 60 and is adapted to prevent particulate material from entering the forward opening.

The hollow cylinder 42 also has two end faces facing in opposite directions. At the rear opening 58, a rear end face 66 faces in a rearward axial direction 68 parallel to the rotational axis 48. At the forward opening 60, a forward end face 70 faces in a forward axial direction 72 parallel to the rotational axis 48. The end faces 66, 70 are perpendicular to the rotational axis 48. Surfaces of the first and second seal devices 62, 64 are in close proximity to and/or in contact with the end faces 66, 70.

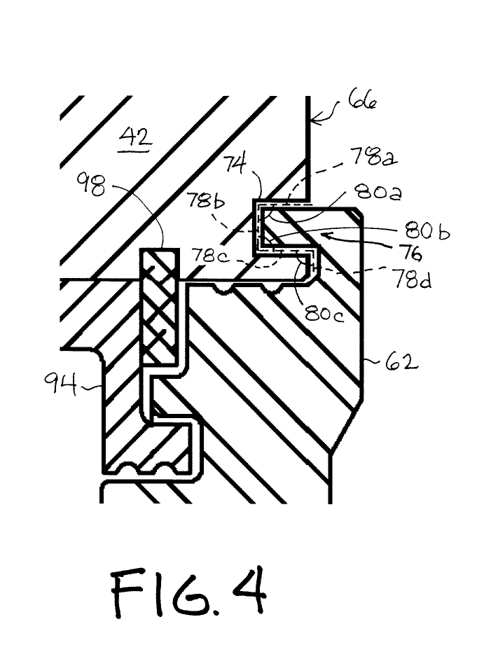

As shown in FIG. 4, the rear end face 66 includes an annular seal feature 74 and the first seal device 62 includes an annular seal feature 76 that is adapted to form a seal with the annular seal feature 74 of the rear end face. The annular seal feature 74 of the rear end face 66 is an annular groove formed into the end face 66. The annular groove extends continuously and appears as a closed circle on the rear end face 66 when viewed in the axial direction 72. The annular seal feature 76 of the first seal device 62 is an annular protrusion that is matingly disposed in the annular groove 74. The surfaces of the protrusion 76 have a shape that corresponds to the shape formed by the surfaces of the groove 74.

The mating relationship provided by the corresponding shapes of the annular seal features 74, 76 provide a labyrinth seal interface depicted by broken line 78. The labyrinth seal interface includes a plurality of seal segments 78a, 78b, 78c, 78d. Segments that are immediately adjacent to each other form interior angles 80a, 80b, 80c which inhibit particulate material from passing entirely through the labyrinth seal. The interior angles are at or about ninety degrees. It will be appreciated that the interior angles may have other values suitable for sealing out particulate material. Examples of other suitable interior angles include without limitation, 135 degrees, 115 degrees, 100 degrees, 80 degrees, 70 degrees, 60 degrees, and 45 degrees.

In the illustrated embodiment of FIG. 4, a clearance gap between the first seal device 62 and the forward end face 66 exists at all the seal segments 78a, 78b, 78c, 78d. The gap facilitates rotation of the hollow cylinder 42 and is preferably sized small enough to prevent particulate material from passing through the labyrinth seal. In some embodiments, the gap is about 0.05 inches across. It will be appreciated that various gap sizes may be used depending on the type and size of particulates in the pellet die. In other embodiments, no gap may exist at any number of the seal segments.

In some embodiments, the labyrinth seal interface includes a plurality of curved segments so as to form one or more S-shapes or a serpentine seal. In yet other embodiments, the annular seal feature of the first seal device 62 is an annular protrusion and the annular seal feature of the rear end face 66 is an annular groove that is shaped to matingly receive the annular protrusion. It will be appreciated that multiple sets of protrusions and grooves can be implemented in various combinations to provide a greater number of seal segments than what is shown in FIG. 4. For example, a seal device may include a protrusion and a groove, while the roller may include a corresponding groove and protrusion.

Referring again to FIG. 3, the first and second seal devices 62, 64 have central bores that allow the seal devices to be mounted on the shaft 46 by mounting components, which include a retaining ring 82 at the rear opening 58 of the hollow cylinder 42, and a lockwasher 84 and an outer lock nut 86 at the forward opening 60. The mounting components prevent the seal devices 62, 64 from slipping axially off of the shaft 46.

Two bearing subassemblies 88 are located between the two seal devices 62, 64. The bearing subassemblies 88 are spaced apart from each other by an outer race spacer 90 and an inner race spacer 92, both of which are located at about the midpoint between the rear and forward openings 58, 60 of the hollow cylinder 42. The inner surface 54 of the hollow cylinder 42 rides on and is supported by the bearing subassemblies 88.

Still referring to FIG. 3, first and second inner collars 94, 96 are located inside the central bore 44 and next to the first and second seal devices 62, 64, respectively. The cross-sectional shape of the inner collars 94, 96 is segmented in such a way that adjacent cross-sectional segments are at or about ninety degrees to each other. The inner collars 94, 96 together with inner diameter grooves in the cylinder bore 44, along with the seal devices 62, 64 form a grooved track for retaining the hollow cylinder 42. A pair of retention rings 98, 100 attached to the inner surface 54 of the hollow cylinder 42 protrude radially inward into the grooved track, which keeps the hollow cylinder from axially slipping off of the shaft 46.

A rear end portion 104 of the shaft 46 is adapted to be removably connected to a stationary mainshaft of the pellet mill. A forward end portion 102 of the shaft 46 is accessible from the opening of the pellet die. A grease fitting or cap 106 located at the rear end portion 104 is adapted to cover one end of a passageway 108 which runs through the shaft 46 and terminates at an opening through the inner race spacer 92. The passageway 108 allows for lubrication to be introduced in the interior space occupied by the bearing subassemblies 88.

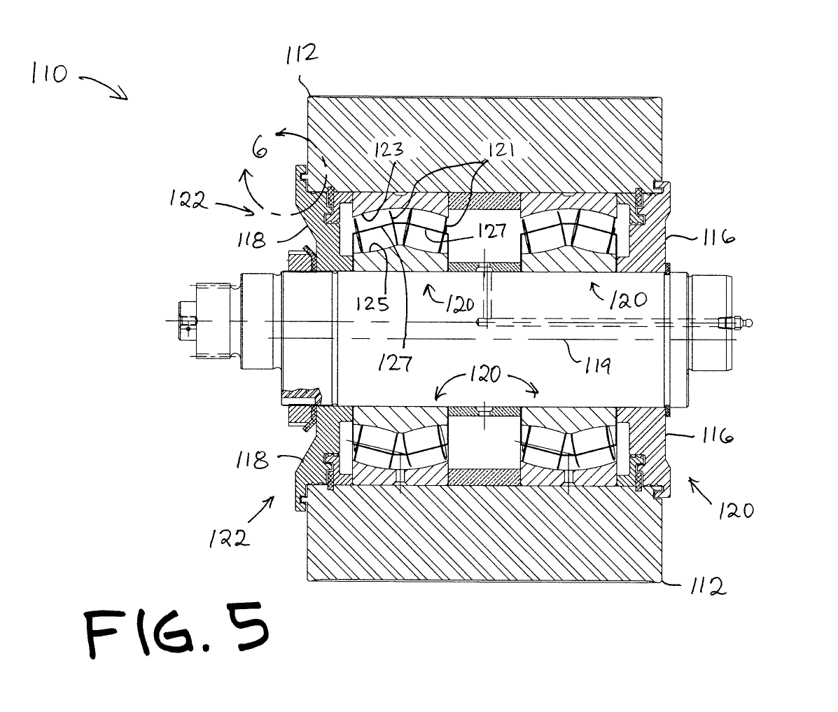

FIG. 5 shows a roller assembly 110 in accordance with another embodiment of the present invention. A hollow cylinder 112 is mounted on a shaft 114 by means of a first seal device 116, a second seal device 118, and bearing subassemblies 120. The bearing subassemblies 120 are sealed from the exterior of roller assembly by the first and second seal devices 116, 118, which are located at rear and forward openings 120, 122, respectively, of the hollow cylinder 112. The first seal device 116 is identical to the first seal device 62 of FIG. 4.

Still referring to FIG. 5, the bearing subassemblies 120 have a spherical roller bearing design with an oil filled polymer, referred to as solid oil. In each bearing subassembly 120 there are two series of bearing rollers 121 arranged in a circle around the rotational axis 119 of cylinder 112. The bearing rollers 121 rotate within and are retained by two concentric ring-shaped raceways or guide tracks. An outer raceway ring 123 includes a sphered raceway surface common to both series of bearing rollers 121. An inner raceway ring 125 includes two separate sphered raceway surfaces for each of the series of bearing rollers 121. The sphered raceway surfaces of the inner ring 125 are inclined at an oblique angle to the bearing axes 127. The sphered raceway surfaces may individually take the form of a portion of toroid surface. The spherical roller bearing design may be of a sealed or unsealed design.

Other bearing designs may be implemented for the bearing subassemblies 120. In some embodiments, a taper roller bearing design may be implemented in which tapered inner and outer raceways contain a series of tapered bearing rollers. In other embodiments, a ball bearing design may be implemented in which concentric inner and outer raceways having either a single or double groove contain a series of round bearing rollers. The ball bearing design may be of a sealed or unsealed type of design. It will be appreciated that other bearing designs may also be implemented, including but not limited to roller bearings known in the art.

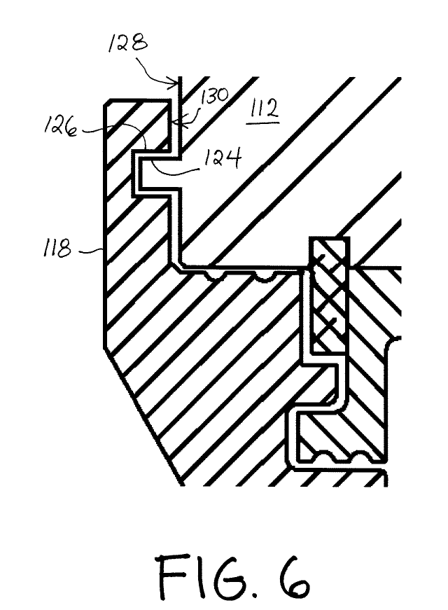

As shown in FIGS. 5 and 6, annular seal features are provided for the forward opening 122 to provide further assurance against entry of particulates and foreign material into the space occupied by the bearing subassemblies 120. The annular seal features comprise an annular protrusion 124 and a correspondingly shaped annular groove 126 at axially facing surfaces 128, 130 of the hollow cylinder 112 and second seal device 118, respectively.

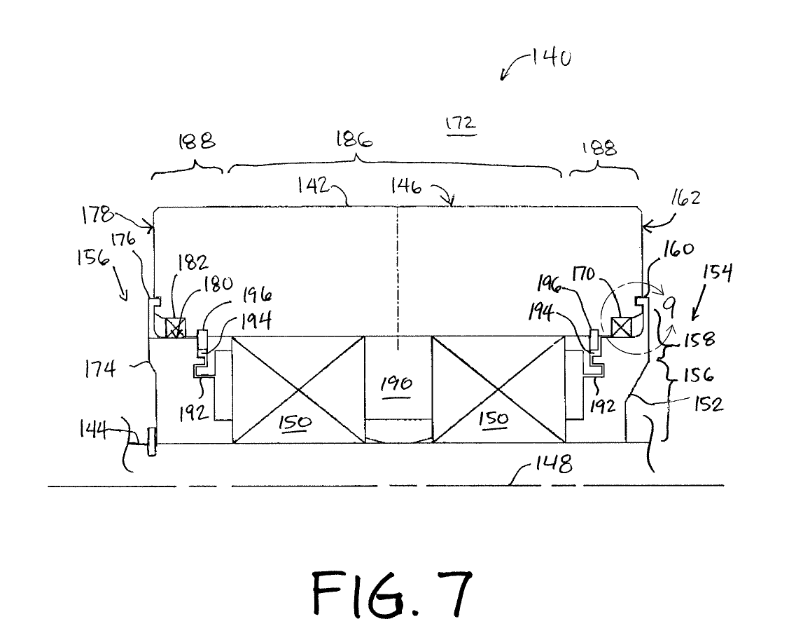

FIG. 7 shows a portion of a roller assembly 140 in accordance with yet another embodiment of the present invention. A roller 142 is mounted around a support shaft 144. When the roller assembly 140 is installed inside a pellet die, an exterior surface 146 of the roller is adapted to push pelleting material through extrusion holes in the pellet die. To facilitate the extrusion process, the roller 142 is adapted to rotate around the support shaft 144 about rotational axis 148. To facilitate rotation, the roller 142 is mounted over rotational bearings 150 disposed between the support shaft 144 and the roller 142. The bearings 150 are sealed off from the exterior 172 of the roller assembly 140 and thus protected from damage or interference by foreign material.

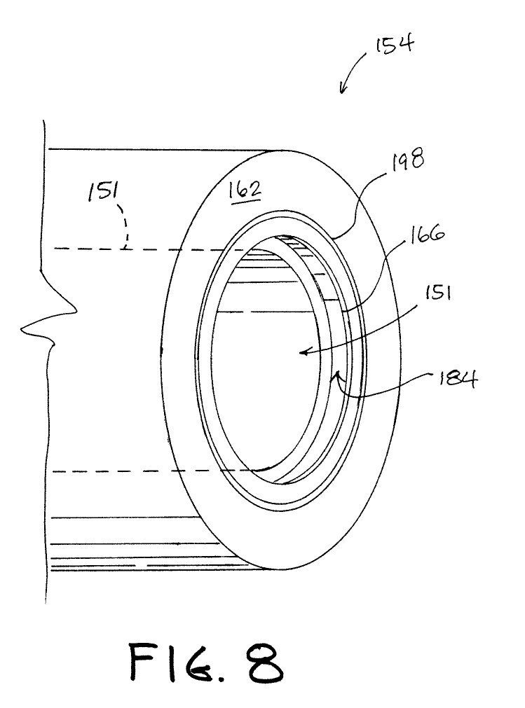

As shown in FIGS. 7 and 8, a bore 151 extends entirely through the roller 142 so as to form open ends 154, 156 at opposite ends of the roller. In other embodiments, the bore may extend partially through a roller so that the roller has only one open end.

Referring again to FIG. 7, a collar 152 is disposed at a first open end 154. The collar 152 includes a collar body 156 and a flange 158. The flange 158 protrudes radially outward from the collar body. A seal portion 160 protrudes axially from the flange 158 and into an axially facing surface 162 of the roller 142. In some embodiments, the seal portion 160 protrudes about 3.8 mm (0.15 inches) into the axially facing surface 162. It will be appreciated that the extent to which the seal portion protrudes into the surface 162 may vary depending on the desired length of the seal interface. A greater length may be desired to increase sealing performance.

As used herein, “axial” directions are oriented parallel or substantially parallel to the rotational axis 148 or a central axis of a cylindrical body, “radial” directions are oriented perpendicular or substantially perpendicular to the rotational axis 148 or a central axis of a cylindrical body, “outward” directions are oriented away from the rotational axis 148 or the central axis, and “inward” directions are oriented toward the rotational axis 148 or the central axis.

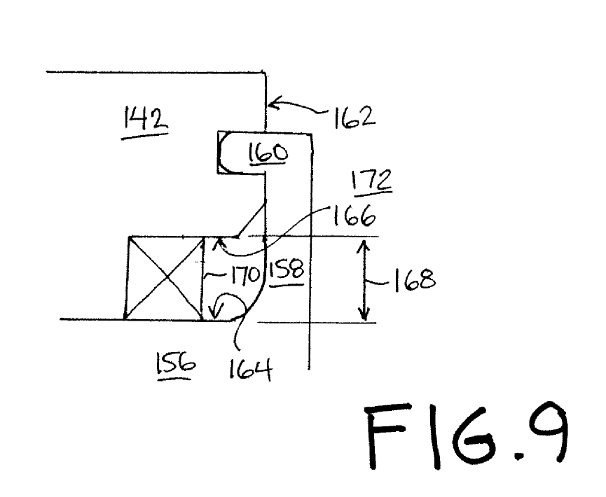

Referring to FIGS. 8-10, the collar body 156 includes a radially outward facing shoulder surface 164. The flange 158 protrudes radially outward from the radially outward facing surface 164. The roller 142 includes a radially inward facing surface 166 which is spaced apart from the radially outward surface 164 by a distance 168. A seal member 170 is disposed between the radially outward and inward facing surfaces 164, 166. The seal member is enclosed by the roller 142, the collar body 156, and the flange 158. The seal portion 162 functions to at least partially seal off the seal member 170 from the exterior 172 of the roller 142. The seal member 170 is adapted to seal the bearings 150 from the exterior 172 of the roller in addition to the seal provided by the seal portion 160. Preferably, though not necessarily, the seal member 170 is in constant sealing contact with the radially outward and inward facing surfaces 164, 166. In some embodiments, the seal member 170 is pressed into contact with the radially outward and inward facing surfaces 164, 166.

In some embodiments, each of the seal members 170, 182 may include a ring-shaped body and a elastic band placed in tension on an outside diameter of the body. The seal member 170 is compressed and held in place by the tensioned band. The seal members 170, 182 may also include an o-ring made of silicone, though other resilient and compliant materials may be used. Preferably, though not necessarily, the silicone and other materials used in the seal members 170, 182 may be of a grade that is suitable for use with food products and for food processing. The o-ring is oriented to continuously press inwardly against the radially outward facing surface 164 of the collar body 156. The seal members may also include a resilient wiper or lip feature that extends around in a circle and is oriented to continuously press outwardly against the radially inward facing surface 166 of the roller 142. The pressing contact by the seal members 170, 182 against the roller 142 and collar bodies 156, 174 prevents material outside the roller assembly 140 from penetrating into the roller assembly and from contaminating the bearings 150, which would then cause failure. It will be appreciated that other seal configurations may be implemented for the seal member 170.

Referring again to FIG. 7, the roller assembly 140 further includes a second collar 174 at the opposite open end 156. The second collar 174 has the same or substantially the same size and shape as the first collar 152. Like the first collar 152, the second collar 174 includes two sealing means: a sealing portion 176 that protrudes into another axially facing surface 178 of the roller 142, and a radially outward facing shoulder surface 180 for sealing against a second sealing member 182.

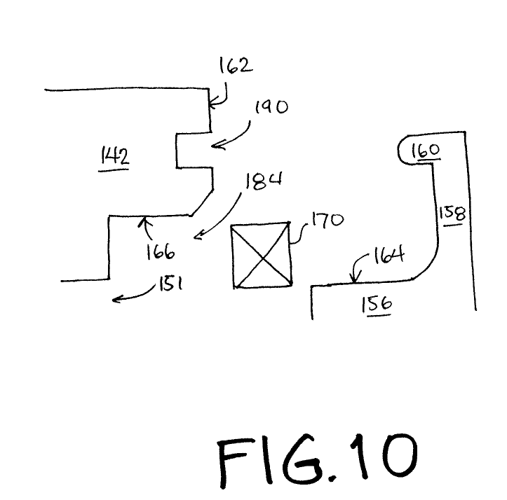

The roller 142 includes a bearing portion 186 and two opposite end portions 188. The bearing portion 186 surrounds the bearings 150, and the end portions surrounding the seal members 170, 182. A counterbore 184 (FIGS. 8 and 10) formed at each of the end portions 188 serves as a recess that receives the seal members 170, 182. In other embodiments, a recess is formed into the collars 156, 174 to receive the seal members 170, 182.

The bearings 150 occupy an interior space 190 between the roller 142 and the support shaft 144. In the embodiment of FIG. 7, the bearings 150 include a solid oil for lubrication, and there is no other lubrication required within the interior space 190 occupied by the bearings 150. The seals 170, 182 along with the labyrinth seals 160, 176 protect the bearings 150 from contamination.

In other embodiments, lubrication within the interior space 190 is allowed to flow through the bearings 150, then through the lubrication passageways 192 and into slots 194 which receive retention rings 196 attached to the roller 142. The lubrication may purge out contaminants that may have entered the roller assembly 140.

As shown in FIG. 8, the axially facing surface 162 has a ring-shaped depression 198 that is concentric with the bore 151. The ring-shaped depression 198 functions as an annular seal feature and is in a sealing relationship with the seal portion 160. In operation, surfaces of the ring-shaped depression 198 rotate relative to the seal portion 160 while the entire roller 142 rotates. The counterbore 184 at each of the end portions 188 are also ring-shaped depressions functioning as annular seal features. Radially inward facing surfaces of the counterbores are preferably in sliding contact with the seal members 170, 182.

In further embodiments, the axially facing surface 162 of the roller 142 includes two or more concentric ring-shaped depressions, each of the depressions sized and shaped to receive one or more seal elements. Preferably, the seal elements maintain a sealing relationship with the ring-shaped depressions so as to keep foreign material out of the space occupied by the bearings 150. The seal elements can be protrusions extending axially from a flange of the collar 152. The protrusions can be made of the same material as the body of the collar. Suitable materials for the protrusions and the collar body include without limitation steel, stainless steel, and other metals and alloys. In other embodiments, one or more of the protrusion can include a resilient material adapted to accommodate compression between the flange and the collar. In yet other embodiments, one or more of the protrusions can include a lubricious material having a lower coefficient of friction with the axially facing surface 162 of the roller 142, as compared to the flange material.

While several particular forms of the invention have been illustrated and described, it will also be apparent that various modifications can be made without departing from the scope of the invention. It is also contemplated that various combinations or subcombinations of the specific features and aspects of the disclosed embodiments can be combined with or substituted for one another in order to form varying modes of the invention. Accordingly, it is not intended that the invention be limited, except as by the appended claims.

What is claimed is:

1. A roller assembly for a pellet mill, the assembly comprising:
a hollow cylinder having a central bore and two end faces facing opposite directions, at least one end face including an annular seal feature;
a first seal device including an annular seal feature adapted to form a seal with the annular seal feature of the at least one end face; and
a second seal device including a seal feature adapted to form a seal with the other end face.

2. The assembly of claim 1, wherein one of the annular seal feature of the at least one end face and the annular seal feature of the first seal device is an annular groove.

3. The assembly of claim 2, wherein the other one of the annular seal feature of the at least one end face and the annular seal feature of the first seal device is an annular protrusion disposed in the annular groove.

4. The assembly of claim 1, wherein the at least one end face further includes a second annular seal feature, and wherein the first seal device further includes a second annular seal feature adapted to form a second seal with the second annular seal feature of the at least one end face.

5. The assembly of claim 1, wherein the second seal device further includes a second seal feature adapted to form a second seal with the other end face of the hollow cylinder.

6. A roller assembly for a pellet mill, the assembly comprising:
a roller having a bore, the roller including an axially facing surface at an open end of the bore; and
a collar at the open end of the bore, the collar including a collar body, a flange protruding radially outward from the collar body, and a seal portion protruding axially from the flange and into the axially facing surface of the roller.

7. The assembly of claim 6, wherein the collar body includes a radially outward facing surface, the flange protruding radially outward from the radially outward facing surface, and wherein the roller includes a radially inward facing surface spaced apart from the radially outward facing surface of the collar body.

8. The assembly of claim 7, further comprising a seal member disposed between and in sealing contact with the radially outward facing surface of the collar body and the radially inward facing surface of the roller.

9. The assembly of claim 6, further comprising a seal member, wherein the roller, the collar body, and the flange of the collar enclose the seal member.

10. The assembly of claim 9, wherein the seal member is sealed from the exterior of the roller by the seal portion of the collar.

11. The assembly of claim 6, further comprising a bearing and a seal member, the bearing disposed in the bore of the roller, the seal member disposed on the collar body, wherein the roller includes a bearing portion and an end portion, the bearing portion surrounding the bearing, the end portion surrounding the seal member and receiving the seal portion of the flange.

12. The assembly of claim 6, further comprising a second collar at a second open end of the bore of the roller, the second collar including collar body, a flange protruding radially outward from the collar body of the second collar, and a seal portion protruding axially from the flange of the second collar and into an axially facing surface at the second open end.

13. The assembly of claim 6, further comprising:
a second collar at a second open end of the bore of the roller; and
a bearing between the two collars.

14. The assembly of claim 13, further comprising a support shaft, the two collars mounted on the support shaft and restraining the roller from axial movement relative to the shaft, the bearing enclosed by the two collars, the roller, and the support shaft.

15. A roller assembly for a pellet mill, the assembly comprising:
a central support;
a bearing on the central support;
a roller on the bearing, the roller adapted to rotate around the central support, the roller including an end face having a ring-shaped feature; and
a seal device including a seal element in a sealing relationship with the ring-shaped feature of the roller end face.

16. The assembly of claim 15, wherein the seal device further includes a second seal element in sliding contact with the roller.

17. The assembly of claim 15, wherein the end face includes a second ring-shaped feature in sliding contact with the seal device.

18. The assembly of claim 15, further comprising a second seal device including a seal element, wherein the roller includes a second end face, the second end face including a ring-shaped feature in a sealing relationship with the seal element of the second seal device.

19. The assembly of claim 18, wherein the second seal device further includes a second seal element and the second end face of the roller includes a second ring-shaped feature in sliding contact with the second seal element of the second seal device.

20. The assembly of claim 18, wherein the bearing is disposed between the two seal devices.
